(19) United States
(12) Patent Application Publication
(10) Pub. No.: US 2026/0006147 A1
(43) Pub. Date: Jan. 1, 2026

(54) INFORMATION PROCESSING APPARATUS PERFORMING DISPLAY ABOUT SECURITY MEASURE, CONTROL METHOD FOR INFORMATION PROCESSING APPARATUS, AND STORAGE MEDIUM

(71) Applicant: CANON KABUSHIKI KAISHA, Tokyo (JP)

(72) Inventor: SHOTA SHIMIZU, Kanagawa (JP)

(21) Appl. No.: 19/247,912

(22) Filed: Jun. 24, 2025

(30) Foreign Application Priority Data
Jun. 27, 2024 (JP) 2024-104373

(51) Int. Cl. H04N 1/44; H04N 1/00

(52) U.S. Cl. CPC H04N 1/4426; H04N 1/00244; H04N 1/00411; H04N 1/4413; H04N 1/4433; H04N 2201/0094

(57) ABSTRACT

A multifunction peripheral is configured in such a manner that, in a case where an application which is used for user authentication is a standard authentication application preliminarily incorporated in firmware of the multifunction peripheral and an authentication server is not used, the multifunction peripheral performs displaying of a security measures status related to multi-factor authentication based on a setting value related to multi-factor authentication, and, in a case where an application which is used for user authentication is an added extension authentication application, regardless of the setting value related to multi-factor authentication, the multifunction peripheral performs displaying indicating that security measures related to multi-factor authentication have previously been taken.

### BACKGROUND

### Field

Aspects of the present disclosure generally relate to an information processing apparatus performing display about security measure, a control method for an information processing apparatus, and a storage medium.

### Description of the Related Art

User authentication is one of measures to protect the security of an information processing apparatus. There are a plurality of types of measures for implementing user authentication including personal identification number (PIN) code, identification (ID) and password, integrated circuit (IC) card, and multi-factor authentication. An authentication which is easier to manage and use is weaker in security according to the degree of easiness of management. Therefore, different measures for implementing user authentication are used depending on the usage environment or use case of an information processing apparatus, but, from a standpoint of security, it is desirable to use multi-factor authentication.

For example, with regard to a multifunction peripheral, in addition to the case of using a user authentication function preliminarily incorporated in firmware thereof, installing an extension application for user authentication on a multifunction peripheral is performed and the extension application makes use of an external authentication server. Even in either case, it is desirable to perform settings in such a way as to use multi-factor authentication.

Japanese Patent Application Laid-Open No. 2023-127338 discusses a technique related to settings of multi-factor authentication. In the technique discussed in Japanese Patent Application Laid-Open No. 2023-127338, in a case where there is no user about which information used for performing multi-factor authentication is currently registered, the settings are prevented from being enabled.

Since settings related to the security of a multifunction peripheral are wide-ranging, it is desirable to provide measures for easily checking a status of security including user authentication and notify the user when settings of multi-factor authentication are possible. For example, with regard to a setting against which security measures are not currently taken, it is desirable to display that an additional setting is possible. On the other hand, depending on user authentication used by a multifunction peripheral, there is a case where, due to an extension application embracing settings related to multi-factor authentication or settings being stored on the server side, firmware of a multifunction peripheral is not able to correctly determine whether settings of multi-factor authentication are possible. Thus, there is an issue in which an information processing apparatus having the function of multi-factor authentication may not be able to correctly determine a case where additional security measures related to multi-factor authentication are possible and thus may not be able to display a security measures status. However, there is no conventional technique which solves such an issue. The above-mentioned technique discussed in Japanese Patent Application Laid-Open No. 2023-127338 is a technique for preventing erroneous settings related to multi-factor authentication and is not the one capable of solving such an issue.

### SUMMARY OF THE DISCLOSURE

Aspects of the present disclosure are generally directed to providing a contrivance capable of determining a case where additional security measures related to multi-factor authentication are possible and prompting the user to use multi-factor authentication, thus increasing security and convenience.

According to an aspect of the present disclosure, an information processing apparatus that provides user authentication using multi-factor authentication functionality includes at least one memory that stores a program, and at least one processor that executes the program and configures the at least one processor to perform operations including: managing a setting value related to multi-factor authentication used in user authentication; and performing display, on a display screen of the information processing apparatus, indicating whether security measures related to multi-factor authentication have previously been taken or whether additional security measures are possible, wherein, in a case where an application which is used for user authentication is a first application and a predetermined condition is satisfied, the display is performed based on the setting value related to the multi-factor authentication, and, in a case where an application which is used for user authentication is a second application, regardless of the setting value related to the multi-factor authentication, the display indicating that security measures related to the multi-factor authentication have previously been taken is performed.

Further features of the present disclosure will become apparent from the following description of exemplary embodiments with reference to the attached drawings.

### BRIEF DESCRIPTION OF THE DRAWINGS

FIG. 1 is a diagram illustrating an example of a hardware configuration of an information processing apparatus according to an exemplary embodiment of the present disclosure.

FIG. 2 is a diagram illustrating an example of a part of a software configuration of the information processing apparatus according to the exemplary embodiment.

FIGS. 3A, 3B, 3C, 3D, 3E, and 3F are diagrams illustrating examples of display screens according to a first exemplary embodiment.

FIG. 4A is a flowchart illustrating an example of processing which is performed to display a security measures status screen.

FIG. 4B is a flowchart illustrating an example of processing which is performed in the first exemplary embodiment.

FIG. 5 is a flowchart illustrating an example of processing which is performed in a second exemplary embodiment.

FIGS. 6A, 6B, 6C, 6D, and 6E are diagrams illustrating examples of display screens according to the second exemplary embodiment.

### DESCRIPTION OF THE EMBODIMENTS

Various exemplary embodiments, features, and aspects of the disclosure will be described in detail below with reference to the drawings.

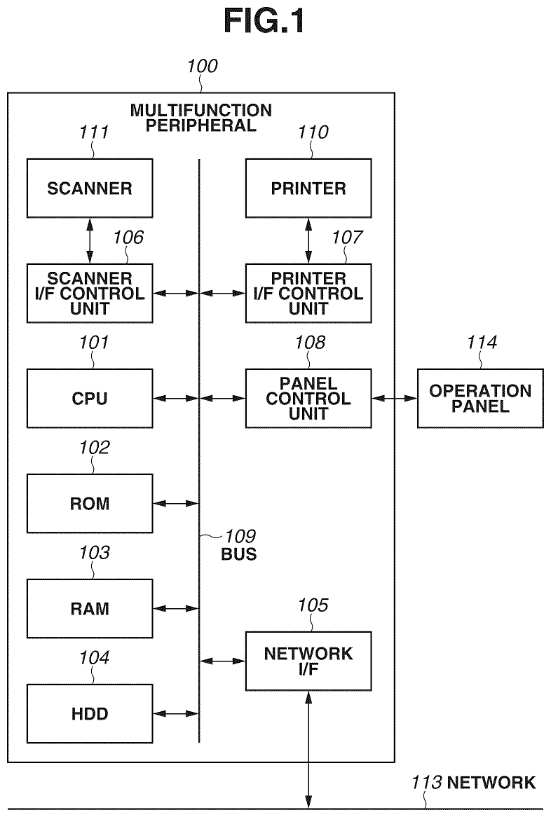

FIG. 1 is a diagram illustrating an example of a hardware configuration of an information processing apparatus according to an exemplary embodiment of the present disclosure. While, here, the exemplary embodiment is described with use of, as an example of an information processing apparatus, a multifunction peripheral 100, which is an image processing apparatus, the exemplary embodiment is not limited to a multifunction peripheral, and the present disclosure can also be applied to various types of computers and smartphones, various types of home electrical appliance, and various other pieces of electronic equipment as long as they are information processing apparatuses having the function of multi-factor authentication.

The multifunction peripheral 100 includes a central processing unit (CPU) 101, which executes software programs for the multifunction peripheral 100 and thus performs control over the entire multifunction peripheral 100.

The multifunction peripheral 100 includes a read-only memory (ROM) 102. In the ROM 102, a boot program, which, in response to the multifunction peripheral 100 being powered on, is first directly read in and executed by the CPU 101, is stored.

The multifunction peripheral 100 includes a random access memory (RAM) 103. The RAM 103 is used for, for example, storing of programs or temporary data when the CPU 101 controls the multifunction peripheral 100.

The multifunction peripheral 100 includes a hard disk drive (HDD) 104. In the HDD 104, programs which are read into the RAM 103 by the boot program and are executed by the CPU 101 are stored. Besides, the HDD 104 is used for storing of data required for a processing operation of the multifunction peripheral 100. Furthermore, the multifunction peripheral 100 can be configured to include another type of storage device, such as a solid state drive (SSD) or an embedded MultiMediaCard (eMMC), instead of or in combination with the HDD.

The CPU 101 implements various control operations by reading out software programs recorded on, for example, the ROM 102 or the HDD 104 onto the RAM 103 and executing the software programs.

A scanner interface (I/F) control unit 106 controls reading of an original which is performed by a scanner 111.

A printer I/F control unit 107 controls, for example, print processing which is performed by a printer 110.

A panel control unit 108 controls an operation panel 114 of the touch panel type, and thus controls displaying of various pieces of information and inputting of instructions received from the user.

A network I/F 105 controls transmission and reception of data via a network 113 with respect to external equipment (not illustrated).

A bus 109 interconnects the CPU 101, the ROM 102, the RAM 103, the HDD 104, the network I/F 105, the scanner I/F control unit 106, the printer I/F control unit 107, and the panel control unit 108. Control signals output from the CPU 101 and data signals to be used between the respective units are transmitted and received via the bus 109.

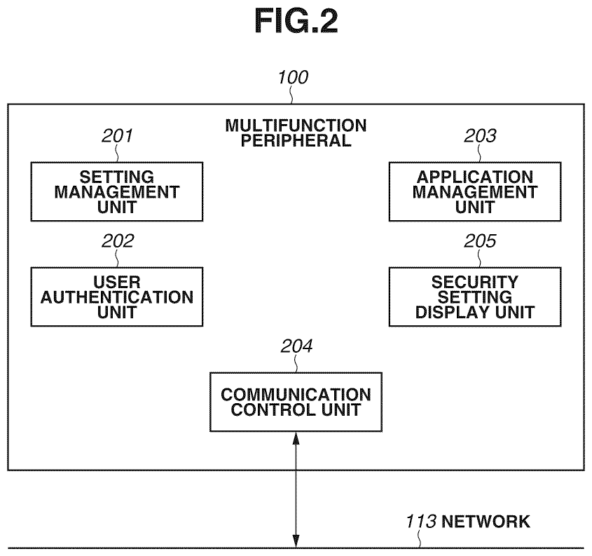

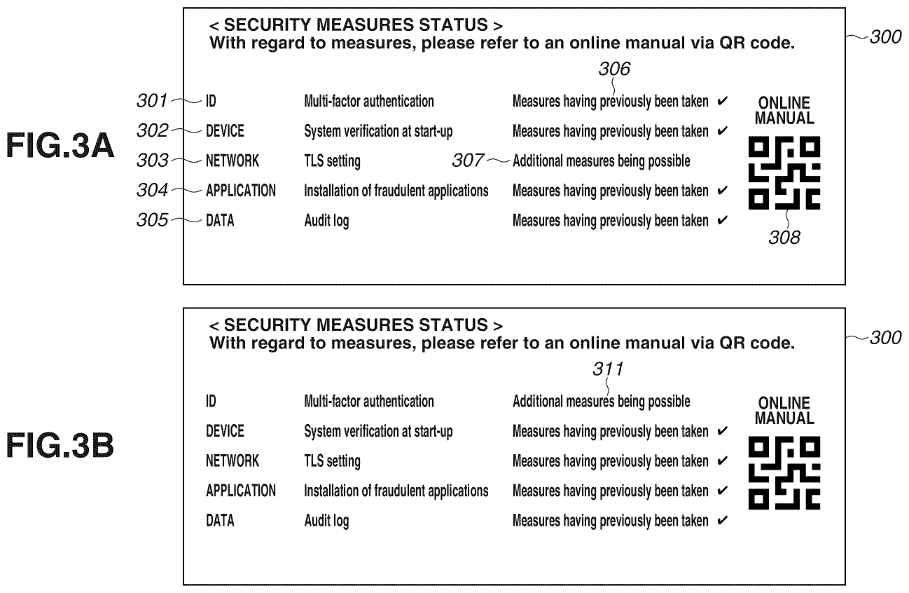

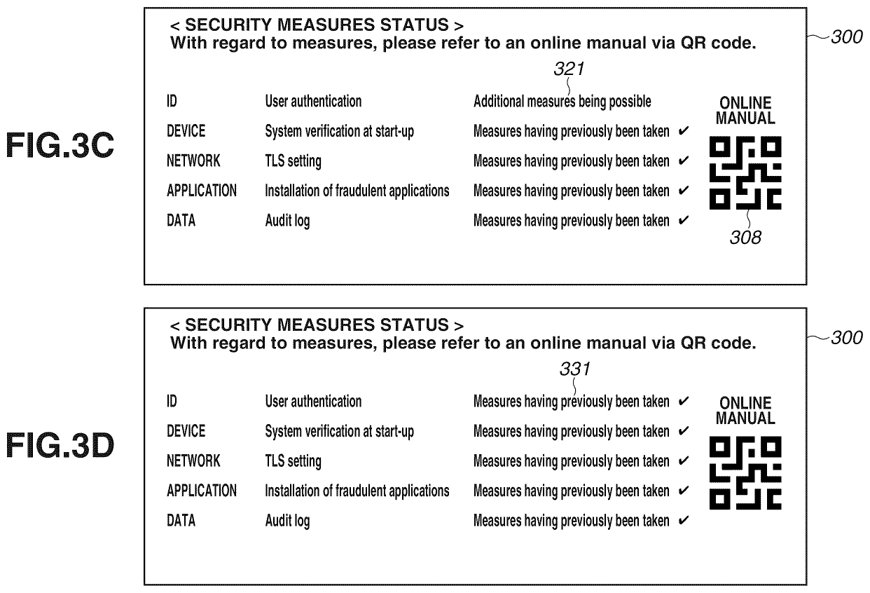

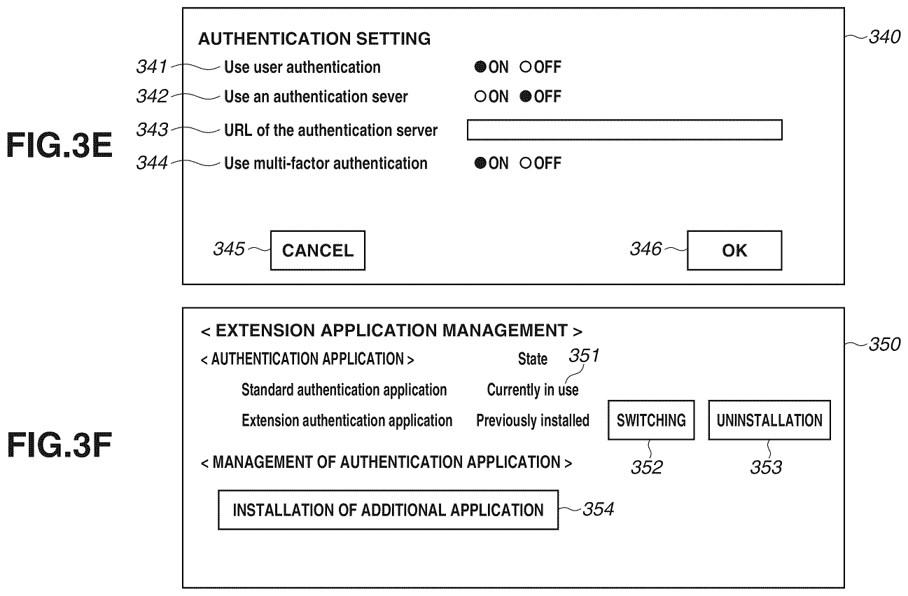

In the following description, a software configuration of the multifunction peripheral 100 is described with reference to FIG. 2 and FIGS. 3A, 3B, 3C, 3D, 3E, and 3F.

FIG. 2 is a diagram illustrating an example of a part of a software configuration of the multifunction peripheral 100. Furthermore, the software configuration illustrated in FIG. 2 is a configuration corresponding to only characteristic portions in the present disclosure, and can further include another software configuration. Software to be described in the following description is assumed to be implemented by the CPU 101 of the multifunction peripheral 100 reading out a program from the ROM 102 or the HDD 104 onto the RAM 103 and executing the program, and, in the following description, the description of the program is omitted.

FIGS. 3A to 3F are diagrams illustrating examples of display screens according to a first exemplary embodiment. Furthermore, while, in the following description, each of the display screens illustrated in FIGS. 3A to 3F is assumed to be displayed on the operation panel 114, a configuration in which such a display screen is displayed in the screen of, for example, a personal computer (PC) connected to the multifunction peripheral 100 via the network 113 is also included in the present disclosure.

Referring to FIG. 2, a setting management unit 201 is software which performs change processing and management of setting values of the multifunction peripheral 100. Upon receiving a setting change instruction issued by the user via the operation panel 114 or the network I/F 105, the setting management unit 201 stores settings input by the user in the HDD 104. Another piece of software reads out setting values from the HDD 104 with use of the setting management unit 201, and performs control of processing according to the setting values.

A user authentication unit 202 provides a user authentication function including multi-factor authentication in the multifunction peripheral 100. The method of providing the user authentication function includes a plurality of methods such as a method in which the user authentication unit 202 performs authentication with use of user information stored within the multifunction peripheral 100 (in the HDD 104) and a method in which the user authentication unit 202 performs user authentication by communicating with an external user authentication server via the network 113. The user authentication in these methods is processed by a standard authentication application preliminarily incorporated in firmware of the multifunction peripheral 100. Moreover, the user authentication unit 202 has the function of substituting a part of the user authentication function with an additional extension application, and is also able to perform user authentication with use of a method in which an extension authentication application added by an application management unit 203 described below processes the user authentication.

Furthermore, while an authentication server is not illustrated, the authentication server can be the one which is implemented by a single computer, can be the one which is implemented by a plurality of computers, or can be a configuration which is implemented with use of a technique for cloud computing.

Here, settings related to an operation of the user authentication unit 202 are described with reference to FIG. 3E. FIG. 3E illustrates an example of a authentication setting screen 340 which is displayed on the operation panel 114 to change settings related to an operation of the user authentication unit 202.

In the authentication setting screen 340, the user is able to perform, via a button 341, switching between ON and OFF of using user authentication. Moreover, the user is able to perform, via a button 342, switching between ON and OFF of using an authentication server and perform, via an entry field 343, setting of a connection destination server in the case of using the authentication server. Moreover, the user is able to perform, via a button 344, switching between ON and OFF of using multi-factor authentication. Then, in response to an OK button 346 being pressed, the content set in the authentication setting screen 340 is then stored in the HDD 104 by the setting management unit 201. Furthermore, in the case of a setting for using an authentication server, depending on configurations of servers, there is a case where the user authentication operates while neglecting “Use multi-factor authentication” set in the authentication setting screen 340 and stored in the HDD 104. In that case, the user authentication operates with the settings stored in the server.

Furthermore, in a case where a cancel button 345 has been pressed, the content set in the authentication setting screen 340 is cancelled.

The description then refers back to FIG. 2.

The application management unit 203 manages installation and uninstallation of an extension application which extends functions with respect to the multifunction peripheral 100.

Here, a setting for using an extension application related to user authentication is described with reference to FIG. 3F. FIG. 3F illustrates an example of an extension application management screen 350 which is displayed on the operation panel 114 to change a setting for using an extension application related to user authentication.

In a case where a standard authentication application preliminarily incorporated in firmware of the multifunction peripheral 100 is “Currently in use” as an indication 351, the user authentication unit 202 performs all of the processing operations related to user authentication. In this case, user authentication is performed according to settings set in the authentication setting screen 340 and stored in the HDD 104.

In the extension application management screen 350, the user is able to perform, via a button 354, additional installation of each of various applications (for example, an authentication application). Moreover, the user is able to switch, via a button 352, the application for use in user authentication to the application added as mentioned above. Furthermore, depending on a configuration of the added application, there is a case where the content set in the above-mentioned authentication setting screen 340 illustrated in FIG. 3E is neglected and the added application runs with settings separately stored in the HDD 104. Moreover, the user is able to uninstall, via a button 353, the application additionally installed as mentioned above.

The description then refers back to FIG. 2.

A communication control unit 204 performs network connection and communication to the network 113 with use of the network I/F 105. In the following description, it is assumed that, in a case where the multifunction peripheral 100 performs communication with another device via the network 113, the communication control unit 204 is operating, and the description of such an operation is omitted.

A security setting display unit 205 provides the function of summarizing some settings related to security included in the settings which are managed by the setting management unit 201 and displaying the summarized settings on the operation panel 114.

In response to the user issuing, via the operation panel 114, an instruction for displaying a security measures status, the security setting display unit 205, upon receiving the issued instruction, collects settings related to security from the setting management unit 201 and thus displays a security measures status screen 300 such as that illustrated in each of FIGS. 3A to 3D on the operation panel 114.

FIGS. 3A to 3D illustrate examples of the security measures status screen 300, which is used for displaying a security measures status, in the first exemplary embodiment.

As illustrated in FIG. 3A, in the security measures status screen 300, items 301 to 305 represent whether security measures by the prevailing standard are currently taken for the multifunction peripheral 100 in terms of items “ID”, “Device”, “Network”, “Application”, and “Data”, respectively. Furthermore, with regard to an item for which security measures are currently taken, for example, as an indication 306 illustrated in FIG. 3A, “Measures having previously been taken” is displayed in the corresponding position. On the other hand, with regard to an item for which security measures are not currently taken, for example, as an indication 307 illustrated in FIG. 3A, “Additional measures being possible” is displayed in the corresponding position. In the example illustrated in FIG. 3A, with respect to the item “Network” 303, “TLS setting . . . Additional measures being possible” is displayed. In this case, the user can refer to an online manual (online documentation) linked from a two-dimensional code 308 such as a QR code® and then appropriately change settings of a usage version for Transport Layer Security (TLS), thus changing the displayed indication to “Measures having previously been taken”. In a case where another item is not currently indicated as “Measures having previously been taken”, the user can also similarly perform changing to appropriate settings, thus changing the displayed indication to “Measures having previously been taken”.

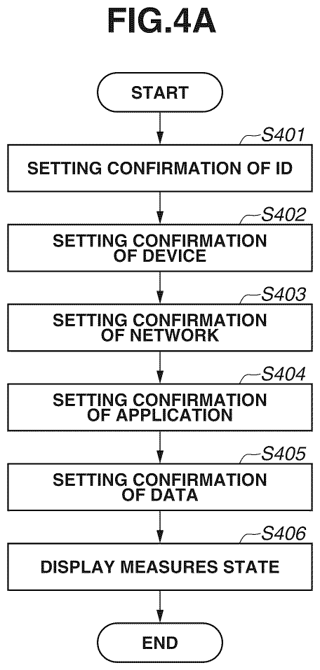

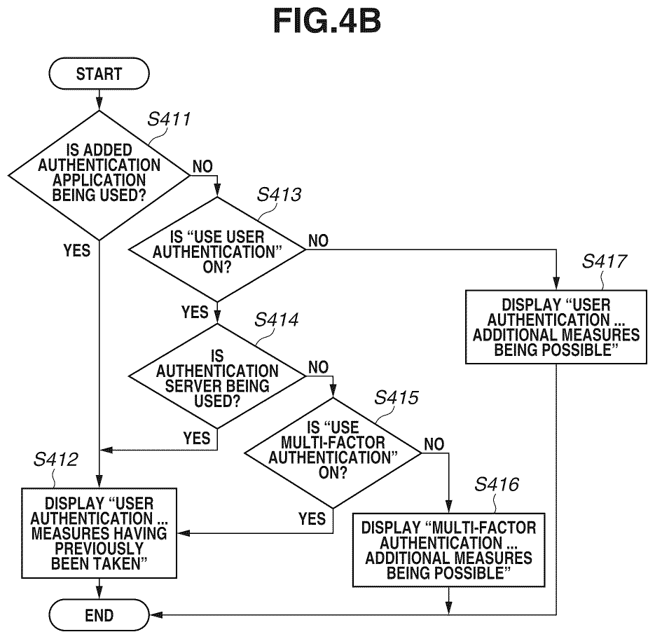

FIG. 4A is a flowchart illustrating an example of processing which the security setting display unit 205 performs to display the security measures status screen 300. Thus, the processing illustrated in the present flowchart is implemented by the CPU 101 of the multifunction peripheral 100 reading out a program stored in the ROM 102 or the HDD 104 onto the RAM 103 and executing the program.

In step S401, the security setting display unit 205 performs setting confirmation of an identification (ID). Thus, the security setting display unit 205 confirms setting of user authentication.

Furthermore, processing for setting confirmation of an ID includes two types of processing operations, i.e., “(1) processing in a case where the user authentication unit 202 has only a method of performing authentication with user information stored in the multifunction peripheral” and “(2) processing in a case where the user authentication unit 202 is able to use a method of performing authentication with use of a server or an extension application”.

First, “(1) processing in a case where the user authentication unit 202 has only a method of performing authentication with user information stored in the multifunction peripheral” is described.

In this case, as the setting confirmation of an ID, the security setting display unit 205 confirms, via the setting management unit 201, whether a multi-factor authentication function is currently enabled. Here, if the multi-factor authentication function is currently enabled, the security setting display unit 205 performs storing in the RAM 103 in such a way as to display “Multi-factor authentication . . . Measures having previously been taken” with respect to the item “ID” 301, as the indication 306 illustrated in FIG. 3A. Moreover, if the multi-factor authentication function is not currently enabled and user authentication is being used, the security setting display unit 205 performs storing in the RAM 103 in such a way as to display “Multi-factor authentication . . . Additional measures being possible” with respect to the item “ID” 301, as an indication 311 illustrated in FIG. 3B. Moreover, if the setting of using neither multi-factor authentication nor user authentication is currently set, the security setting display unit 205 performs storing in the RAM 103 in such a way as to display “User authentication . . . Additional measures being possible” with respect to the item “ID” 301, as an indication 321 illustrated in FIG. 3C. While, here, the security setting display unit 205 performs determination based on only the setting of the multi-factor authentication function, the security setting display unit 205 can comprehensively perform determination by confirming relevant settings such as the state of enabling of user authentication, on which multi-factor authentication is premised, and the state of registration of a user account.

Furthermore, “(2) processing in a case where the user authentication unit 202 is able to use a method of performing authentication with use of a server or an extension application” is described below with reference to FIG. 4B.

Moreover, in step S402, as the setting confirmation of a device, the security setting display unit 205 confirms, via the setting management unit 201, whether a tamper detection function is currently enabled. Here, if the tamper detection function is currently enabled, the security setting display unit 205 performs storing in the RAM 103 in such a way as to display “System verification at start-up . . . Measures having previously been taken” with respect to the item “Device” 302, as illustrated in FIG. 3A. While, here, the security setting display unit 205 performs determination based on only the tamper detection function, the security setting display unit 205 can perform determination according to the setting of another security related to a device such as whether a Trusted Platform Module (TPM) is currently enabled. Moreover, the security setting display unit 205 can perform determination based on a combination of a plurality of settings.

Moreover, in step S403, as the setting confirmation of a network, the security setting display unit 205 confirms, via the setting management unit 201, whether the version of Transport Layer Security (TLS) is limited to greater than or equal to “1.2”. If the version of TLS is limited to greater than or equal to “1.2”, the security setting display unit 205 performs storing in the RAM 103 in such a way as to display “TLS setting . . . Measures having previously been taken” with respect to the item “Network” 303, as illustrated in FIG. 3B. Furthermore, the security setting display unit 205 can perform determination based on settings related to processing for TLS such as algorithms usable for other than the TLS version. Furthermore, the security setting display unit 205 can perform determination based on settings of a network protocol other than TLS.

Moreover, in step S404, as the setting confirmation of an application, the security setting display unit 205 confirms, via the setting management unit 201, whether a setting in which other than legitimate applications are unable to be installed is currently made. Here, if a setting in which other than legitimate applications are unable to be installed is currently made, the security setting display unit 205 performs storing in the RAM 103 in such a way as to display “Installation of fraudulent applications . . . Measures having previously been taken” with respect to the item “Application” 304, as illustrated in FIG. 3A. Furthermore, the security setting display unit 205 can perform determination based on other settings related to the protection of applications such as whether antivirus software is currently enabled for the protection of applications. Moreover, in a case where there is no setting in which other than legitimate applications are unable to be installed or in the case of a multifunction peripheral which does not allow an additional program to be installed thereon, regardless of the settings, the security setting display unit 205 can determine that measures have previously been taken without exception and perform displaying to that effect.

Moreover, in step S405, as the setting confirmation of data protection, the security setting display unit 205 confirms, via the setting management unit 201, whether an audit log function is currently enabled. Here, if the audit log function is currently enabled, the security setting display unit 205 performs storing in the RAM 103 in such a way as to display “Audit log . . . Measures having previously been taken” with respect to the item “Data” 305, as illustrated in FIG. 3A. Thus, in the multifunction peripheral 100, the user is able to confirm, via audit logs, an operation history such as upload, download, and printing with respect to confidential documents which are performed via the multifunction peripheral 100. Furthermore, the audit log function can also be considered as the viewpoint of protection specific to a printer specialized for handling of business documents. Moreover, in a case where the multifunction peripheral 100 is equipped with a more sophisticated function such as the function of analyzing recorded logs, the security setting display unit 205 can perform determination based on the state of enabling of the log analysis function. Moreover, the security setting display unit 205 can perform determination based on whether the function of protecting the HDD 104 by encryption is currently enabled as the viewpoint of data protection other than audit logs.

Furthermore, while, in the examples illustrated in FIGS. 3A to 3D and FIG. 4A, displaying is assumed to be performed in terms of five items “ID”, “Device”, “Network”, “Application”, and “Data”, displaying can also be performed in terms of items other than the above-mentioned items. Moreover, the security setting display unit 205 can perform processing for determination in a multiple manner based on a plurality of settings.

Moreover, the processing order of the above-mentioned steps S401 to S405 is not limited to the above-described sequential order, but can be an optional sequential order for processing to be performed.

Next, in step S406, the security setting display unit 205 displays, on the operation panel 114, each of the results stored in the RAM 103 in the above-mentioned steps S401 to S405 as illustrated in FIGS. 3A to 3D. Furthermore, with respect to an item for which storing related to displaying is not performed in the RAM 103, “Additional measures being possible” is displayed on the operation panel 114.

Through the above-described processing, displaying of the security measures status screen 300 is complete.

Next, in processing for the setting confirmation of an ID performed in step S401, “(2) processing in a case where the user authentication unit 202 is able to use a method of performing authentication with use of a server or an extension application” is described with reference to FIG. 4B.

In the case of performing user authentication with use of a server or an extension application, the user authentication unit 202 receives an authentication result from the authentication server or the extension application and provides a function corresponding to the authentication result to the multifunction peripheral 100. On this occasion, the server or the extension application can also be configured to uniquely store settings without use of the setting management unit 201 and operate accordingly, and, therefore, the user authentication unit 202 is unable to detect which authentication method has been used for user authentication. As a result, the user authentication unit 202 is also unable to detect whether multi-factor authentication has been used, and the above-mentioned “(1) processing in a case where the user authentication unit 202 has only a method of performing authentication with user information stored in the multifunction peripheral” does not enable the setting confirmation of an ID to be correctly performed.

Therefore, “(2) processing in a case where the user authentication unit 202 is able to use a method of performing authentication with use of a server or an extension application”, which is described below with reference to FIG. 4B, is used.

FIG. 4B is a flowchart illustrating an example of processing which the user authentication unit 202 performs in the first exemplary embodiment. Thus, the processing illustrated in the present flowchart is implemented by the CPU 101 of the multifunction peripheral 100 reading out a program stored in the ROM 102 or the HDD 104 onto the RAM 103 and executing the program.

Furthermore, the processing illustrated in the present flowchart corresponds to processing which the user authentication unit 202 starts to perform after the security setting display unit 205 inquires of the user authentication unit 202 about a display content when performing a processing operation in step S401 (the setting confirmation of an ID) illustrated in FIG. 4A.

Upon receiving an inquiry about a display content from the security setting display unit 205, the user authentication unit 202 performs processing operations in steps S411 to S417. The processing operations are described below in detail.

In step S411, the user authentication unit 202 acquires settings of application management via the setting management unit 201, and determines whether a setting of using an extension authentication application added by the application management unit 203 is currently made.

Here, if it is determined that a setting of using the added extension authentication application is currently made (YES in step S411), the user authentication unit 202 advances the processing to step S412.

In step S412, the user authentication unit 202 performs storing in the RAM 103 in such a way to display “User authentication . . . Measures having previously been taken” with respect to the item “ID” 301, as an indication 331 illustrated in FIG. 3D, and then ends the processing in the present flowchart. After that, the processing which the security setting display unit 205 performs transitions to step S402.

On the other hand, if, in the above-mentioned step S411, it is determined that a setting of not using the added extension authentication application is currently made (NO in step S411), the user authentication unit 202 advances the processing to step S413.

In step S413, the user authentication unit 202 acquires a setting of “Use user authentication” 341 via the setting management unit 201, and determines whether a setting of using user authentication is currently made (“Use user authentication” 341 is ON).

Here, if it is determined that a setting of not using user authentication is current made (“Use user authentication” 341 is OFF) (NO in step S413), the user authentication unit 202 advances the processing to step S417.

In step S417, the user authentication unit 202 performs storing in the RAM 103 in such a way to display “User authentication . . . Additional measures being possible” with respect to the item “ID” 301, as an indication 321 illustrated in FIG. 3C, and then ends the processing in the present flowchart. After that, the processing which the security setting display unit 205 performs transitions to step S402.

On the other hand, if, in the above-mentioned step S413, it is determined that a setting of using user authentication is currently made (“Use user authentication” 341 is ON) (YES in step S413), the user authentication unit 202 advances the processing to step S414.

In step S414, the user authentication unit 202 acquires a setting of “Use an authentication server” 342 via the setting management unit 201, and determines whether a setting of using an authentication server is currently made (“Use an authentication server” 342 is ON).

Here, if it is determined that a setting of using an authentication server is currently made (“Use an authentication server” 342 is ON) (YES in step S414), the user authentication unit 202 advances the processing to step S412.

On the other hand, if it is determined that a setting of not using an authentication server is currently made (“Use an authentication server” 342 is OFF) (NO in step S414), the user authentication unit 202 advances the processing to step S415.

In step S415, the user authentication unit 202 acquires a setting of “Use multi-factor authentication” 344 via the setting management unit 201, and determines whether a setting of using multi-factor authentication is currently made (“Use multi-factor authentication” 344 is ON).

Here, if it is determined that a setting of using multi-factor authentication is currently made (“Use multi-factor authentication” 344 is ON) (YES in step S415), the user authentication unit 202 advances the processing to step S412.

On the other hand, if it is determined that a setting of not using multi-factor authentication is currently made (“Use multi-factor authentication” 344 is OFF) (NO in step S415), the user authentication unit 202 advances the processing to step S416.

In step S416, the user authentication unit 202 performs storing in the RAM 103 in such a way to display “Multi-factor authentication . . . Additional measures being possible” with respect to the item “ID” 301, as an indication 311 illustrated in FIG. 3B, and then ends the processing in the present flowchart. After that, the processing which the security setting display unit 205 performs transitions to step S402.

Thus, in a case where the application which is used for user authentication is a standard authentication application preliminarily incorporated in firmware of the multifunction peripheral 100 and a condition in which an authentication server is not used is satisfied (thus, NO in step S411 and NO in step S414), the user authentication unit 202 performs display control in such a way as to display a status of security measures related to multi-factor authentication based on setting values related to multi-factor authentication (steps S415, S416, and S412).

Moreover, in a case where the application which is used for user authentication is an added extension authentication application (thus, YES in step S411), regardless of setting values related to multi-factor authentication, the user authentication unit 202 performs display control in such a way as to display that security measures related to multi-factor authentication have previously been taken (step S412).

Additionally, with regard to items other than multi-factor authentication, the user authentication unit 202 performs display control in such a way as to display whether security measures for each item have previously been taken or whether additional security measures for each item are possible, based on setting values related to each item.

While, in the above description, a configuration in which, in response to an inquiry about a display content received from the security setting display unit 205, the user authentication unit 202 performs each processing operation illustrated in FIG. 4B has been described, a configuration in which the security setting display unit 205 performs some or all of the processing operations illustrated in FIG. 4B can also be employed.

As described above, since the security setting display unit 205 and, for example, the user authentication unit 202 perform display control of a security measures status, according to the first exemplary embodiment, in a case where additional measures for multi-factor authentication are possible by settings of the multifunction peripheral 100, it is possible to display that effect to notify the user.

Furthermore, in a case where an added extension authentication application is being used (YES in step S411) or in a case where server authentication is being used (YES in step S414), instead of performing a processing operation in step S412, processing or displaying for prompting the user to refer to a manual for an authentication application or server authentication because of security measures related to multi-factor authentication being uncertain and check whether a setting of using multi-factor authentication is currently made can be performed.

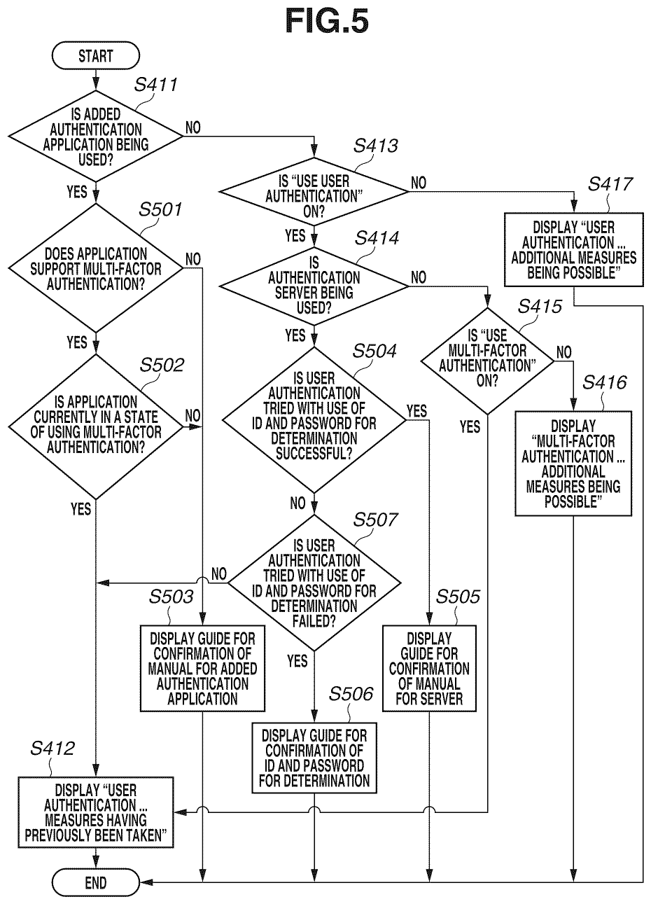

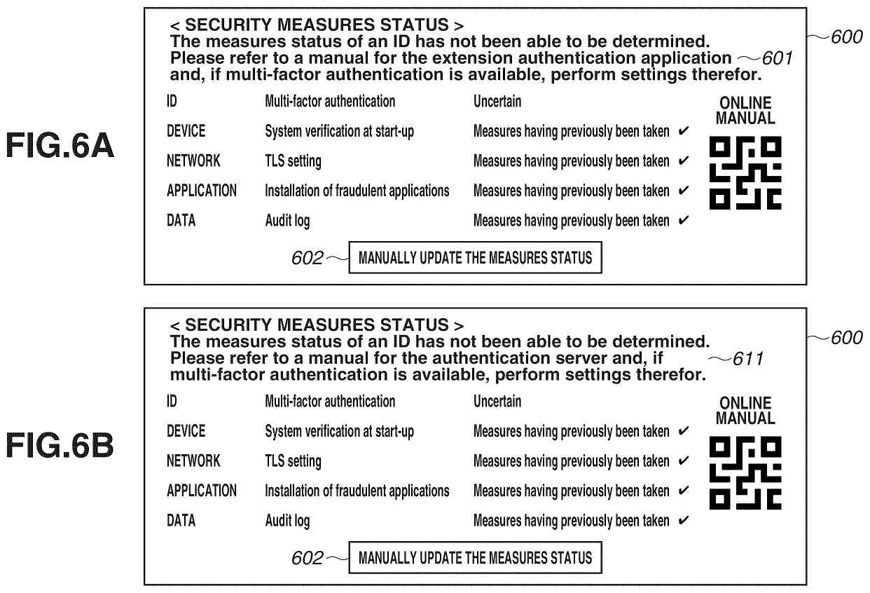

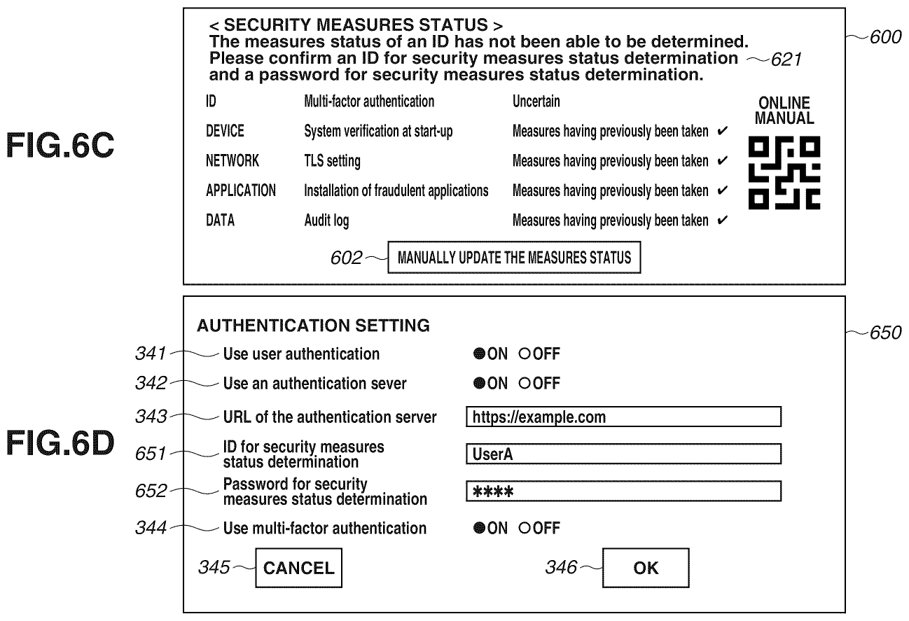

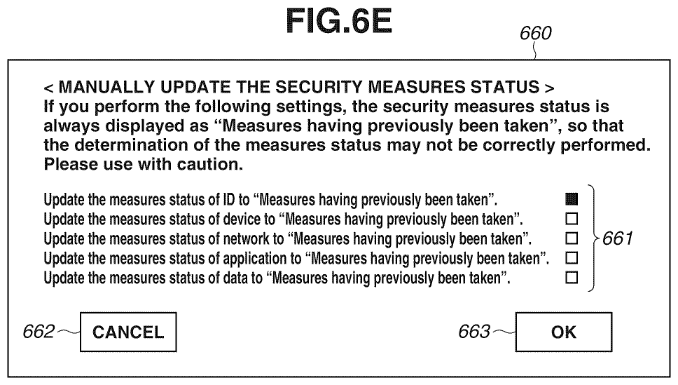

In the above-described first exemplary embodiment, a configuration in which, in a case where an added extension authentication application is being used or a case where server authentication is being used, regardless of setting values related to multi-factor authentication, “User authentication . . . Measures having previously been taken” is displayed so that the user is not guided to additional measures for multi-factor authentication has been described. In a second exemplary embodiment, a configuration in which, even in a case where an added extension authentication application is being used or a case where server authentication is being used, a case where additional measures for multi-factor authentication are possible is correctly determined wherever possible and the user is guided to using multi-factor authentication wherever possible is described. The details of the configuration are described below with reference to FIG. 5 and FIGS. 6A, 6B, 6C, 6D, and 6E.

FIG. 5 is a flowchart illustrating an example of processing which the user authentication unit 202 performs in the second exemplary embodiment. Thus, the processing illustrated in the present flowchart is implemented by the CPU 101 of the multifunction peripheral 100 reading out a program stored in the ROM 102 or the HDD 104 onto the RAM 103 and executing the program.

FIGS. 6A to 6E are diagrams illustrating examples of display screens according to the second exemplary embodiment.

Furthermore, the processing illustrated in the flowchart of FIG. 5 corresponds to processing which the user authentication unit 202 starts to perform after the security setting display unit 205 inquires of the user authentication unit 202 about a display content when performing a processing operation in step S401 (the setting confirmation of an ID) illustrated in FIG. 4A.

Upon receiving an inquiry about a display content from the security setting display unit 205, the user authentication unit 202 performs processing operations in steps S411 to S417 and steps S501 to S506 each illustrated in the flowchart of FIG. 5. The processing operations are described below in detail. Furthermore, the same steps as those illustrated in FIG. 4B are assigned the respective same step numbers as those in FIG. 4B, and the description thereof is omitted here.

In the second exemplary embodiment, if, in step S411 illustrated in FIG. 5, it is determined by the user authentication unit 202 that a setting of using the added extension authentication application is currently made (YES in step S411 illustrated in FIG. 5), the user authentication unit 202 advances the processing to step S501.

In step S501, the user authentication unit 202 acquires information indicating whether the added extension authentication application supports multi-factor authentication from the application management unit 203. For example, in a case where the method of implementing the added extension authentication application is using Open Services Gateway initiative (OSGi) by Java, the information is able to be transmitted with a setting file called a manifest. In this case, a header definition which declares multi-factor authentication support can be prepared to ask the application to declare. Furthermore, the method of acquiring information indicating whether the added extension authentication application supports multi-factor authentication does not necessarily need to be this method, but can be, for example, a method of forcing the added extension authentication application to mount thereon an application programming interface (API) for acquiring predetermined information or a method of forcing the added extension authentication application to store the information in a predetermined region of the RAM 103 or the HDD 104.

Here, if the user authentication unit 202 has not been able to acquire information indicating that the added extension authentication application supports multi-factor authentication (NO in step S501), the user authentication unit 202 advances the processing to step S503.

In step S503, the user authentication unit 202 performs storing in the RAM 103 in such a way as to display a confirmation message indicating, for example, that “The measures status of an ID has not been able to be determined. Please refer to a manual for the extension authentication application and, if multi-factor authentication is available, perform settings therefor.” as an indication 601 illustrated in FIG. 6A, and then ends the processing in the present flowchart. After that, the processing which the security setting display unit 205 performs transitions to step S402.

FIGS. 6A to 6C illustrate examples of a security measures status screen 600, which is displayed to indicate a security measures status in the second exemplary embodiment.

On the other hand, if, in the above-mentioned step S501, the user authentication unit 202 has been able to acquire information indicating that the added extension authentication application supports multi-factor authentication (YES in step S501), the user authentication unit 202 advances the processing to step S502.

In step S502, the user authentication unit 202 determines whether the added extension authentication application is currently in a state of using multi-factor authentication. If the added extension authentication application is assumed to be required to mount thereon the above-mentioned API for acquiring information in the case of declaring multi-factor authentication support, the user authentication unit 202 becomes able to acquire the setting state. Furthermore, the method of acquiring the state does not necessarily need to be this method, but can be a method of, for example, forcing the added extension authentication application to store the setting state in a predetermined region of the HDD 104.

Here, if it is determined that the added extension authentication application is currently in a state of using multi-factor authentication (YES in step S502), the user authentication unit 202 performs a processing operation in step S412, and then ends the processing in the present flowchart.

On the other hand, if it is determined that the added extension authentication application is not currently in a state of using multi-factor authentication (NO in step S502), the user authentication unit 202 performs a processing operation in step S503, and then ends the processing in the present flowchart.

Moreover, in the second exemplary embodiment, if it is determined that a setting of using an authentication server is currently made (“Use an authentication server” 342 is ON) (YES in step S414 illustrated in FIG. 5), the user authentication unit 202 advances the processing to step S504.

In step S504, the user authentication unit 202 determines whether user authentication internally tried by an authentication server, instead of the user, with use of an ID for security measures status determination and a password for security measures status determination preliminarily set as entry fields 651 and 652 illustrated in FIG. 6D and stored in the HDD 104 is successful.

Here, settings related to an operation of the user authentication unit 202 in the second exemplary embodiment are described with reference to FIG. 6D. FIG. 6D illustrates an example of an authentication setting screen 650 in the second exemplary embodiment. The authentication setting screen 650 is, for example, a screen which is displayed on the operation panel 114 by the setting management unit 201, and the same elements therein as the respective elements in the authentication setting screen 340 in the first exemplary embodiment are assigned the respective same reference characters as those in the authentication setting screen 340.

The authentication setting screen 650 includes, in addition to the constituent elements in the first exemplary embodiment, an entry field 651 for an ID for security measures status determination and an entry field 652 for a password for security measures status determination.

After settings of an ID for security measures status determination and a password for security measures status determination are performed by the user, the settings are then stored in the HDD 104 by the setting management unit 201. In a processing operation in the above-mentioned step S504, the ID for security measures status determination and the password for security measures status determination are used.

The description then refers back to step S504 illustrated in FIG. 5.

Then, if the user authentication unit 202 has received a notification indicating that user authentication is successful from the authentication server, i.e., if user authentication in the authentication server is successful (YES in step S504), the user authentication unit 202 determines that “Multi-factor authentication is not currently enabled”, and then advances the processing to step S505.

In step S505, the user authentication unit 202 performs storing in the RAM 103 in such a way as to display a confirmation message indicating, for example, that “The measures status of an ID has not been able to be determined. Please refer to a manual for the authentication server and, if multi-factor authentication is available, perform settings therefor.” as an indication 611 illustrated in FIG. 6B, and then ends the processing in the present flowchart. After that, the processing which the security setting display unit 205 performs transitions to step S402.

On the other hand, if the user authentication unit 202 has not received a notification indicating that user authentication is successful from the authentication server, i.e., if user authentication in the authentication server is unsuccessful (NO in step S504), the user authentication unit 202 advances the processing to step S507.

In step S507, the user authentication unit 202 determines whether user authentication in the authentication server is failed.

If the user authentication unit 202 has received a notification indicating that user authentication is failed from the authentication server, i.e., if user authentication in the authentication server is failed (YES in step S507), the user authentication unit 202 advances the processing to step S506.

In step S506, the user authentication unit 202 performs storing in the RAM 103 in such a way as to display a confirmation message indicating, for example, that “The measures status of an ID has not been able to be determined. Please confirm an ID for security measures status determination and a password for security measures status determination.” as an indication 621 illustrated in FIG. 6C, and then ends the processing in the present flowchart. After that, the processing which the security setting display unit 205 performs transitions to step S402.

On the other hand, if the user authentication unit 202 has not received a notification indicating that user authentication is failed from the authentication server, i.e., if user authentication in the authentication server is not failed (NO in step S507), the user authentication unit 202 determines that “Multi-factor authentication is currently enabled”, performs a processing operation in step S412, and then ends the processing in the present flowchart.

As described above, since the security setting display unit 205 and, for example, the user authentication unit 202 perform display control of a security measures status, according to the second exemplary embodiment, it is possible to prompt the user to use multi-factor authentication in a greater number of cases than in the first exemplary embodiment.

Furthermore, while, in the above description, a processing method of, in a case where user authentication is neither successful nor failed in steps S504 and S507, determining that “Multi-factor authentication is currently enabled” has been described, this method does not necessarily need to be employed. For example, a method in which, in response to a request for displaying an additional authentication screen being communicated from the authentication server to the multifunction peripheral 100 via the network 113, the authentication server determines that “Multi-factor authentication is currently enabled” can also be employed.

While, in the above description, a configuration in which, in response to an inquiry about a display content received from the security setting display unit 205, the user authentication unit 202 performs each processing operation illustrated in FIG. 5 has been described, a configuration in which the security setting display unit 205 performs some or all of the processing operations illustrated in FIG. 5 can also be employed.

Moreover, there is a case where, even if the added extension authentication application supports multi-factor authentication, information indicating that the added extension authentication application supports multi-factor authentication is not able to be acquired, the result of determination in step S501 is NO, and, in step S503, a confirmation message such as the indication 601 illustrated in FIG. 6A is displayed. This includes, for example, a case where the added extension authentication application supports multi-factor authentication but does not declare multi-factor authentication support in the manifest. In such a case, although the user has succeeded in multi-factor authentication in the added extension authentication application, a confirmation message such as the indication 601 illustrated in FIG. 6A is always displayed, so that the user may find it annoying. In that situation, the user can press a “Manually update the measures status” button such as a button 602 illustrated in FIG. 6A and then manually change each item of the security measures to “Measures having previously been taken”. The details thereof are described below.

In response to the “Manually update the measures status” button 602 being pressed, the security setting display unit 205 displays, on the operation panel 114, a manual update screen 660 for manually updating a security measures status such as that illustrated in FIG. 6E.

In the manual update screen 660, checkboxes 661 are provided for the respective security items, and the user can check each checkbox 661 and thus change the security measures of the checked item to “Measures having previously been taken”. Furthermore, in response to an OK button 663 being pressed, information about the item checked in the corresponding checkbox 661 provided in the manual update screen 660 is then stored in the HDD 104 by the setting management unit 201.

Furthermore, in a case where a cancel button 662 has been pressed, the content set in the manual update screen 660 is cancelled.

In the case of the second exemplary embodiment, in step S406 illustrated in FIG. 4A, the security setting display unit 205 acquires information about an item checked in the checkbox 661 in the manual update screen 660 illustrated in FIG. 6E from the HDD 104 via the setting management unit 201, and, with regard to the checked item, displays “Additional measures being possible” on the operation panel 114 regardless of the results stored in the RAM 103 in steps S401 to S405 illustrated in FIG. 4A.

Furthermore, while, in the second exemplary embodiment, a configuration which confirms a security measures status and guides the user to the confirmation of a manual with respect to each of the case of using the added extension authentication application and the case of using the authentication server has been described, a configuration which implements that processing with respect to only one of the above-mentioned cases is also included in the present disclosure.

Moreover, in the description of the second exemplary embodiment, as the indication 601 illustrated in FIG. 6A, a message is displayed in such a way as to prompt the user to confirm a manual for the extension authentication application or a manual for the authentication server. However, a two-dimensional code, such as a QR Code®, with a Uniform Resource Locator (URL) for such a manual embedded therein can also be displayed together with a two-dimensional code for an online manual for the multifunction peripheral main body.

As described above, according to each of the above-described exemplary embodiments, it is possible to determine a case where additional security measures related to multi-factor authentication are possible and prompt the user to use multi-factor authentication, thus increasing security and convenience.

Furthermore, the structures of the above-mentioned various pieces of data and the contents thereof are not limited to those described above, and, naturally, can be altered to various structures and contents according to use applications and purposes.

While various exemplary embodiments have been described above, the present disclosure can be embodied as exemplary embodiments serving as, for example, a system, an apparatus, a method, a program, and a storage medium. Specifically, the present disclosure can be applied to a system composed of a plurality of pieces of equipment, or can be applied to an apparatus composed of one piece of equipment.

Moreover, all of the configurations each obtained by combining aspects of the above-described exemplary embodiments are also included in the present disclosure.

The present disclosure can also be implemented by processing for supplying a program for implementing one or more functions of the above-described exemplary embodiments to a system or apparatus via a network or a storage medium and causing one or more processors included in a computer of the system or apparatus to read out and execute the program. Moreover, the present disclosure can also be implemented by a circuit which implements one or more functions of the above-described exemplary embodiments (for example, an application specific integrated circuit (ASIC)).

Moreover, the present disclosure can also be applied to a system composed of a plurality of pieces of equipment, or can also be applied to an apparatus composed of one piece of equipment.

The present disclosure is not limited to the above-described exemplary embodiments, and can be modified in various manners (including an organic combination of some of the exemplary embodiments) based on the gist of the present disclosure, and such modifications are not excluded from the scope of the present disclosure. Thus, all of the configurations each obtained by combining aspects of the above-described exemplary embodiments and modifications thereof are also included in the present disclosure.

According to aspects of the present disclosure, it is possible to determine a case where additional security measures related to multi-factor authentication are possible and prompt the user to use multi-factor authentication, thus increasing security and convenience.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-104373 filed Jun. 27, 2024, which is hereby incorporated by reference herein in its entirety.

1. An information processing apparatus that provides user authentication using multi-factor authentication functionality, the information processing apparatus comprising:
at least one memory that stores a program; and
at least one processor that executes the program and configures the at least one processor to perform operations comprising:
managing a setting value related to multi-factor authentication used in user authentication; and
performing display, on a display screen of the information processing apparatus, indicating whether security measures related to multi-factor authentication have previously been taken or whether additional security measures can be performed,
wherein, in a case where an application which is used for user authentication is a first application and a predetermined condition is satisfied, the display is performed based on the setting value related to the multi-factor authentication, and, in a case where an application which is used for user authentication is a second application, regardless of the setting value related to the multi-factor authentication, the display indicating that security measures related to the multi-factor authentication have previously been taken is performed.

2. The information processing apparatus according to claim 1, wherein the predetermined condition is determined to be satisfied when an authentication server is not used for the user authentication.

3. The information processing apparatus according to claim 1, wherein, execution of the program further configured the at least processor to perform operations including:
performing display indicating whether security measures have previously been taken or whether additional security measures can be performed is performed even with respect to an item other than the multi-factor authentication in addition to the display indicating whether security measures related to multi-factor authentication have previously been taken or whether additional security measures can be performed.

4. The information processing apparatus according to claim 3, wherein the item other than the multi-factor authentication includes at least one of items including system verification at start-up, Transport Layer Security (TLS) setting, installation of fraudulent applications, and audit log.

5. The information processing apparatus according to claim 1,
wherein execution of the program further configured the at least processor to perform operations including: performing installation for adding an application to the information processing apparatus,
wherein the second application is the application added by the installation, and
wherein the information processing apparatus uses a plurality of applications including the first application and the second application, each of the plurality of applications serving as an application which is used for the user authentication while switching between the plurality of applications.

6. The information processing apparatus according to claim 2,
wherein, the setting value includes a combination of an identification (ID) and a password as security measures used in user authentication with the authentication server, and
wherein, in a case where an application which is used for the user authentication is the first application, the predetermined condition is not satisfied, and the authentication is successful when authentication using the authentication server has been tried with use of a combination of the ID and the password, display for prompting a user to confirm a manual for the authentication server and to use multi-factor authentication is performed.

7. The information processing apparatus according to claim 6, wherein, in a case where an application which is used for the user authentication is the first application and the predetermined condition is not satisfied, regardless of the setting value related to the multi-factor authentication, performing display indicating that security measures related to the multi-factor authentication have previously been taken when authentication using the authentication server has been tried with use of a combination of the ID and the password and the authentication being neither successful nor failed, or a request from the authentication server is display requesting additional authentication.

8. An information processing apparatus that provides user authentication using multi-factor authentication functionality, the information processing apparatus comprising:
at least one memory that stores a program; and
at least one processor that executes the program and configures the at least one processor to perform operations comprising:
managing a setting value related to multi-factor authentication used in user authentication;
performing display, on a display screen of the information processing apparatus, indicating whether security measures related to multi-factor authentication have previously been taken or whether additional security measures can be performed;
confirming whether a second application includes multi-factor authentication functionality; and
confirming whether a setting state related to the multi-factor authentication in the second application is currently in a state of using the multi-factor authentication when it is confirmed that the second application has the function of multi-factor authentication,
wherein, when the second application is used to perform the user authentication and regardless of the setting value related to the multi-factor authentication,
display indicating that security measures related to the multi-factor authentication have previously been taken is performed in response to having been able to confirm that the setting state related to the multi-factor authentication in the second application is currently in a state of using the multi-factor authentication, and,
performing display urging confirmation for the second application to use multi-factor authentication is performed in response to not having been able to confirm that the setting state related to the multi-factor authentication in the second application is currently in a state of using the multi-factor authentication.

9. The information processing apparatus according to claim 8,
wherein execution of the program further configured the at least processor to perform operations including, regardless of the application which is used in the user authentication and the setting value related to the multi-factor authentication, performing updating of a setting for updating a state of security measures related to the multi-factor authentication to measures having previously been taken, and
wherein, display indicating that security measures related to the multi-factor authentication have previously been taken is performed when the updating has been performed.

10. The information processing apparatus according to claim 1, wherein the information processing apparatus is an image processing apparatus comprising at least one of a scanner and a printer.

11. A control method for an information processing apparatus that provides user authentication using multi-factor authentication functionality and manages a setting value related to multi-factor authentication used in user authentication, the control method comprising:
performing display, on a display screen of the information processing apparatus, indicating whether security measures related to multi-factor authentication have previously been taken or whether additional security measures can be performed,
wherein, in a case where an application which is used for user authentication is a first application and a predetermined condition is satisfied, the display is performed based on the setting value related to the multi-factor authentication, and, in a case where an application which is used for user authentication is a second application, regardless of the setting value related to the multi-factor authentication, the display indicating that security measures related to the multi-factor authentication have previously been taken is performed.

12. A non-transitory computer-readable storage medium storing computer-executable instructions that, when executed by a computer, cause the computer to perform a control method for an information processing apparatus that provides user authentication using multi-factor authentication functionality and manages a setting value related to multi-factor authentication used in user authentication, the control method comprising:
performing display, on a display screen of the information processing apparatus, indicating whether security measures related to multi-factor authentication have previously been taken or whether additional security measures can be performed,
wherein, in a case where an application which is used for user authentication is a first application and a predetermined condition is satisfied, the display is performed based on the setting value related to the multi-factor authentication, and, in a case where an application which is used for user authentication is a second application, regardless of the setting value related to the multi-factor authentication, the display indicating that security measures related to the multi-factor authentication have previously been taken is performed.
